(19) United States
(12) Patent Application Publication
(10) Pub. No.: US 2010/0185871 A1
(43) Pub. Date: Jul. 22, 2010

(54) SYSTEM AND METHOD TO PROVIDE SECURE ACCESS TO PERSONAL INFORMATION

(75) Inventors: Jeff Scherrer, Bothell, WA (US); MaryAnn Scherrer, Bothell, WA (US)

Correspondence Address: PERKINS COIE LLP;PATENT-SEA, P.O. BOX 1247, SEATTLE, WA, 98111-1247, US

(73) Assignee: Authentiverse, Inc., Bothell, WA (US)

(21) Appl. No.: 12/688,823

(22) Filed: Jan. 15, 2010

Related U.S. Application Data
(60) Provisional application No. 61/145,069, filed on Jan. 15, 2009.

(51) Int. Cl. G06F 21/00; G06F 7/04

(52) U.S. Cl. 713/186; 726/4; 726/5; 726/7

(57) ABSTRACT

A personal information system allowing users to securely collect, store, and transfer personal information is disclosed. The personal information system provides a central location for users to store information, and allows third parties to securely access the information in accordance with user-defined access rules. By providing a central storage area that may be electronically accessed by third parties, the personal information system facilitates the transfer of user information to these third parties. In order to control access to a user's stored personal information, user-defined access rules define the conditions under which third parties may access the stored information. The system also provides user authentication devices that include biometric recognition components and a touch screen display. The user authentication devices may be installed at third party locations to enable a user to authorize the transfer of personal information to third parties.

### CROSS-REFERENCE TO RELATED APPLICATION

This application claims the benefit of U.S. Provisional Application No. 61/145,069, entitled “SYSTEM AND METHOD TO PROVIDE SECURE ACCESS TO PERSONAL INFORMATION,” filed on Jan. 15, 2009, which is incorporated herein by reference in its entirety.

### BACKGROUND

In this, the Information Age, personal information plays a valuable role in many aspects of an individual's life. Entities throughout most sectors of society are interested in collecting personal information and using the information for any of a number of purposes. For example, an individual may be required to provide their name, home address, phone number, social security number, etc. to a financial institution in order to open a new account or to apply for a loan. The financial institution may use the received information to confirm the identity of the user, perform a credit check, distribute important documents, etc. As another example, an individual may provide their name and email address in order to join a retailer's loyalty program. The retailer may use the received information to direct advertisements to the individual based on the individual's spending habits. Thus, an individual may be encouraged or incentivized to provide personal information to various entities to facilitate transactions in which the individual is interested in participating or to optimize the services that those entities provide the individual.

Although required, typical mechanisms through which individuals provide personal information to entities can be time-consuming, subject to human error, non-secure, and repetitive. For example, when an individual visits a doctor's office for the first time, the individual is often required to provide an array of personal information, such as name, social security number, emergency contact information, insurance information, etc. In order to provide this information, the individual is asked to fill out lengthy and, at times, misleading or confusing forms. Although some of the information may be easy for the individual to remember and provide, the individual may have forgotten or misremembered some of the information or may not have the proper documents to accurately provide this information. Moreover, the individual may be distracted when filling out the forms and may complete them inaccurately or incompletely. Furthermore, the person responsible for transcribing the individual's forms may do so inaccurately either out of inattentiveness or merely because the person could not read the individual's handwriting.

While the doctor's office may only ask the individual to fill out forms one time, the user may be subjected to these or similar forms when the individual visits another doctor's office for the first time. Additionally, an individual may be required to provide the same or similar information during other transactions, such as during a job application process with a potential employer, at a gym when starting a new membership, at an educational institution when applying for admission, at a car rental agency when renting a car, etc. Another problem is that the individual may not be given any guarantees that the personal information that the individual provides will be kept secure from unauthorized parties. Although the individual may be interested in transacting with an entity, the individual may decide not to partake in certain transactions to avoid being overwhelmed by the form completion process or out of fear that the user's personal information may not be kept secure.

### BRIEF DESCRIPTION OF THE DRAWINGS

FIG. 1A is a block diagram showing an environment in which a system to collect, store, and transfer a user's personal information may operate.

FIG. 1B is a block diagram depicting the components of a user authentication device utilized to access the user's stored personal information.

FIG. 2 is a data table containing a user's personal information such as may be stored by the personal information system.

FIG. 3 is a perspective diagram of a user authentication device having a display with a user interface for authorizing access to stored personal information.

FIG. 4 is a user interface that allows a user to access and view personal information in a template.

FIG. 5 is a flow diagram illustrating steps performed by an access component of the personal information system.

FIG. 6 is a flow diagram illustrating steps performed by a form filler component of the personal information system.

### DETAILED DESCRIPTION OF THE SYSTEM

A personal information system allowing users to securely collect, store, and allow access to personal information is disclosed. The personal information system provides a central location for users to store personal information and allows third parties to securely access the information in accordance with user-defined access rules. The personal information may be stored within an information repository as a number of attributes, such as name, home address, social security number, current employer, medical conditions, entertainment preferences, etc. The personal information may also include a number of electronic versions of various documents, such as a birth certificate, a driver's license, a diploma, and so on. The personal information may also include any form of media, such as images, video, audio, or links to information stored outside of a user's information repository. By providing a central storage area that may be electronically accessed by third parties, the personal information system facilitates the transfer of user information to third parties.

In some embodiments, the personal information system may associate a timestamp with each change made to an attribute or document stored within a user's information repository. In this manner, historical information about the user can easily be retrieved from the user's information repository.

In order to control access to a user's stored personal information, user-defined access rules define the conditions under which third parties may access the stored personal information. The access rules can be defined on a third party-by-third party basis or for a group of third parties. Moreover, each access rule can be defined to apply to a single document or attribute within an information repository or to apply to a group of documents, a group of attributes, or some combination thereof. A user can associate temporal limitations on the access rules, such as a time period during which the access rules are to be applied and/or the extent to which a third party can access a user's historical information.

The system also provides user authentication devices that include biometric recognition components and a touch screen display. The authentication devices are used to authenticate users and allow users to access their information repository. The user authentication devices may be installed at third party locations to enable a user to authorize the transfer of personal information to third parties. For example, a user may authenticate themselves at the Department of Licensing by providing a sequence of fingerprints. If the Department of Licensing has any forms for the user to fill out, the forms can be displayed on the touch screen display for the user to view and complete. Furthermore, certain fields of the form can be automatically populated with information retrieved from the user's information repository in accordance with the user's predefined access rules associated with the Department of Licensing. Furthermore, the authentication device may allow the user to define access rules associated with the Department of Licensing.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

Various embodiments of the invention will now be described. The following description provides specific details for a thorough understanding and enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments.

### I. Personal Information Storage System

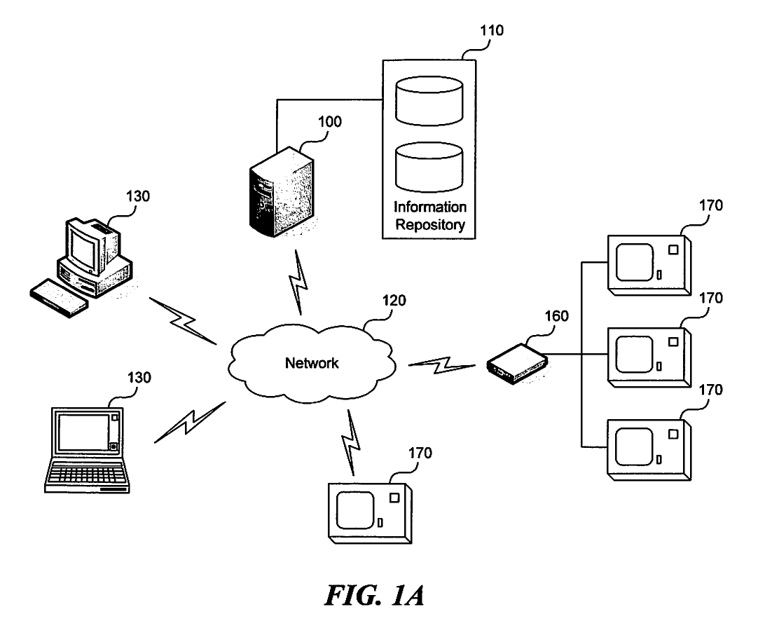

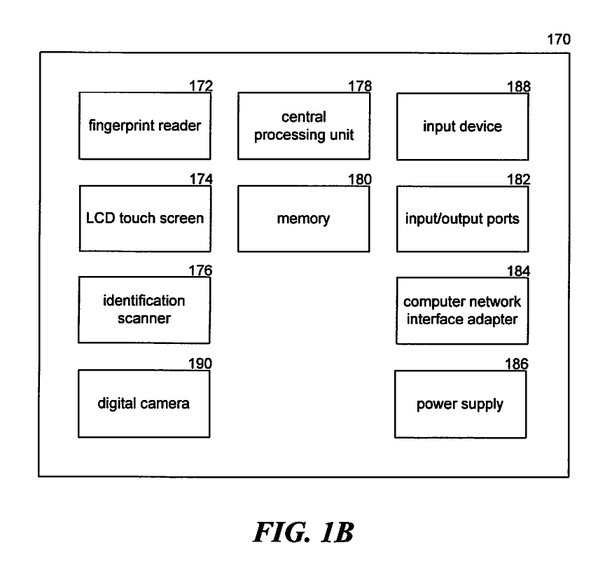

FIG. 1A is a block diagram of an environment in which a system that allows users to collect, store, and transfer personal information may operate. The personal information system provides a central location for users to store information, and allows third parties to securely access the information in accordance with user-defined access rules. By providing a central storage area that may be electronically accessed by third parties, the personal information system facilitates the transfer of user information to other parties. For example, the system virtually eliminates the need for a user to fill out paperwork for purposes of exchanging personal information with a bank, medical facility, government agency, educational institution, mortgage company, business, service company, or any party requiring access to personal information (collectively referred to herein as a “third party”). As another example, a third party may use the personal information system to support a promotional program, such as a loyalty or “punch card” program. Rather than presenting a card at the time of purchase, a user may simply identify herself to the third party via an authentication mechanism.

The personal information system includes a number of distributed components that allow secure storage as well as secure access to personal information. A service provider may operate one or more servers 100 that are coupled to an information repository 110. The information repository contains information pertaining to system users. The information repository stores any personal information about a user, such as:
a user's name, address, date of birth, gender, marital status, etc.;
a user's financial information, such as information about a user's bank accounts, stock portfolio, income, credit reports, etc.;
a user's medical information, such as information about a user's medical insurance, primary care provider, allergies, treatment histories, various images, such as x-rays or photographs of medical conditions, lab reports, etc.,
any other information about a user.

For purposes of this description, any unit of information that is stored about a user will be referred to as an “attribute.” In some embodiments, the information repository may store electronic versions of documents (e.g. scanned documents, documents in portable document format (pdf), etc.) or any other form of media (e.g., images, video, audio). For example, the information repository may store electronic versions of a user's birth certificate, driver's license, high school diploma, contracts, pay stubs, resumes, certificates, college transcripts, etc. In some embodiments, the information repository stores a combination of attributes and electronic versions of documents. Those skilled in the art will appreciate that the information repository may physically comprise one or more storage devices, such as hard drives, optical drives, tape drives, or other storage devices or arrays of storage devices. Such physical storage media may be local to or remote from the one or more servers.

Servers 100 implement the storage and access functionality described herein. Specifically, the servers allow a user and third parties to access stored personal information using a secure Application Programming Interface (API). Users and third parties may be allowed to retrieve stored information from the information repository provided that they authorized to do so and have otherwise met the required security protocols. Users and third parties may also be allowed to write personal information to the information repository provided that they are authorized to do so and have otherwise met the required security protocols. In some embodiments, the personal information system may provide user authentication and information distribution services on behalf or in conjunction with a third party online storage service.

As used herein, servers 100 include any computing system including personal computers, server computers, minicomputers, mainframe computers, multiprocessor systems, microprocessor-based systems, distributed computing environments that include any of the foregoing, and the like. Such computing systems may include one or more processors that execute software to perform the functions described herein. Processors include programmable general-purpose or special-purpose microprocessors, programmable controllers, application specific integrated circuits (ASICs), programmable logic devices (PLDs), or the like, or a combination of such devices. Software may be stored in memory, such as random access memory (RAM), read-only memory (ROM), flash memory, or the like, or a combination of such components. Software may also be stored in one or more storage devices, such as magnetic or optical based disks, flash memory devices, or any other type of non-volatile storage medium for storing data. Software may include one or more program modules which include routines, programs, objects, components, data structures, and so on that perform particular tasks or implement particular abstract data types. The functionality of the program modules may be combined or distributed across multiple computing systems or devices as desired in various embodiments.

A user or third party may access stored personal information in a variety of different ways. For example, a user may remotely access the user's personal information using a computer 130 that is connected to server 100 via a public or private computer network 120, such as the Internet, a local area network, a wide area network, a point-to-point dial-up connection, or a mobile device network. As will be described in additional detail here, the user may upload, store, and modify personal information. The user may also define one or more access rules that determine whether third parties may access the stored information and the conditions under which such access will be granted.

A user may also access the stored personal data using a user authentication device 170. As will be described in additional detail herein, the user authentication device is a dedicated device that includes a fingerprint recognition component (or other biometric recognition component) and a touch screen display. User authentication devices are typically installed at third party locations to enable a user to authorize the transfer of personal information to the third party where the user authentication device is installed. A single user authentication device 170 may be directly connected to server 100 via a public or private computer network 120. Alternatively, a number of user authentication devices 170 may be networked together via a communications hub 160 and connected to server 100 via a public or private computer network 120. Using the user authentication device, the user may authorize the sharing of personal information with a third party or parties.

FIG. 1B is a block diagram depicting the components of a user authentication device 170 that allows a user to access the user's stored personal information. The user authentication device has a fingerprint reader 172 and associated software that detects a user's fingerprint and matches it to a stored fingerprint. A representative fingerprint reader that is suitable for use in the user authentication device is the U.are.U 4500 Fingerprint Module, manufactured by digitalPersona of Redwood City, Calif. The user authentication device 170 includes a LCD touch screen 174 that displays information to a user and allows the user to enter information and commands, such as rules for accessing stored personal information. A representative LCD touch screen that is suitable for use in the user authentication device is the PER-LCD-11105-R 6.4″ LCD Panel with Resistive Touch manufactured by EMAC, Inc. of Carbondale, Ill. The user authentication device 170 also includes an identification scanner 176, such as a driver's license scanner, for scanning additional information about the user. The user authentication device includes a central processing unit 178, memory and/or storage 180, input/output ports 182, a computer network interface adapter 184, a power supply 186, and an input device 188 (e.g., keyboard, touch screen, etc.). Stored in memory and/or storage 180 are instructions to implement the functionality described herein, and may includes such elements as an operating system and an application to process biometric data. Such instructions are executed by the central processing unit. In some embodiments, a digital camera 190 may be present to capture an image of a user that uses the authentication device.

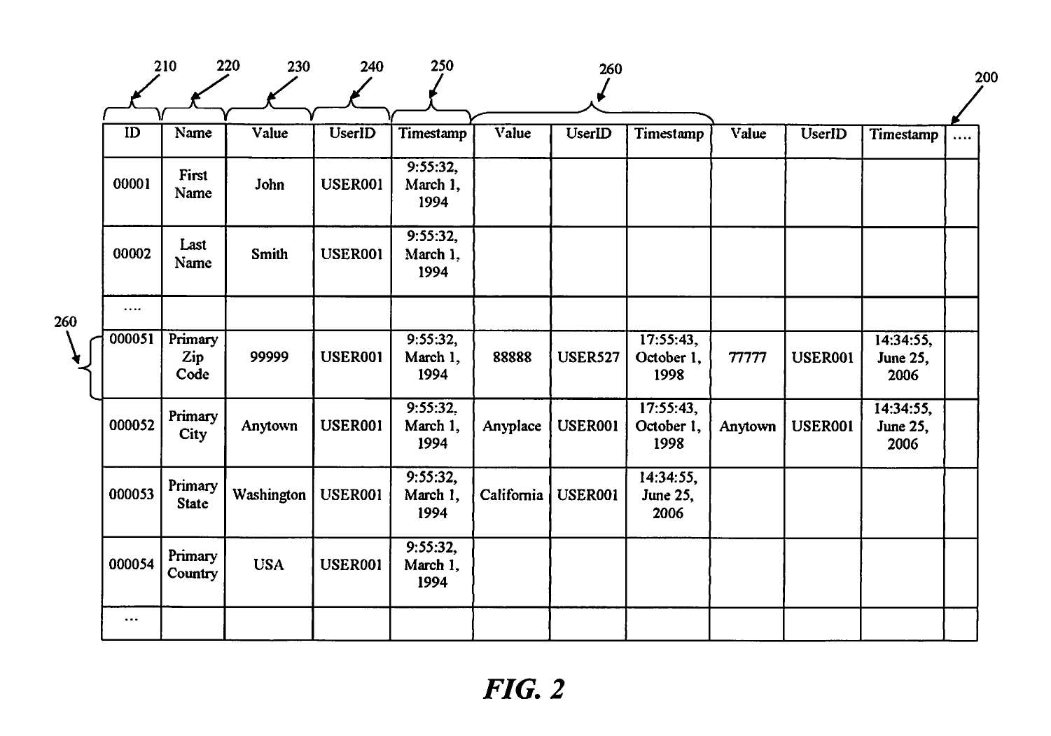

FIG. 2 is a data table 200 depicting how a user's personal information may be stored by the personal information system. Those skilled in the art will recognize that while FIG. 2 provides an illustration comprehensible to the human reader, the information may actually be stored in any form and contain any number of values. Table 200 contains a list of various attributes associated with the user, an indication of the source of each attribute, and a record of whether each attribute was modified, and if so, by whom. Each attribute is assigned a unique ID number, which is stored in column 210, and a name, which is stored in column 220. The value of each attribute is stored in column 230. A user identifier corresponding to the identity of the individual that provided the attribute value is stored in column 240, and the date and time that the attribute value was received by the system is stored as a timestamp in column 250. Each time an attribute is modified, an additional set of data 260 is appended to the table, including the new value of the attribute, a timestamp representing the date and time at which the attribute was modified, and a user identifier identifying the party that modified the attribute. As an example, row 260 depicts the history of an attribute representing a zip code of a user's primary residence. The attribute represented in row 260 has been assigned a unique identifier of 000051, which is stored in column 210. In some embodiments, each row that is added to the table is assigned a unique identifier. In some embodiments the service provider has pre-established an association between unique identifiers and attributes. The second cell in row 260 indicates that the name of the attribute is “Primary Zip Code.” In some embodiments, attribute names are determined when rows are added to the table. In some embodiments, the service provider pre-establishes an association of attribute names and attributes. The next three cells in row 260, associated with columns 230, 240, and 250, show that on Mar. 1, 1994, USER001 assigned an initial value to the primary zip code of 99999. The next three cells show that on Oct. 1, 1998, an authorized user having a User ID USER527 changed the primary zip code to 88888, and the final three cells in row 260 show that USER001 changed the primary zip code to 77777. As will be appreciated by the discussion that follows, maintaining a time and date record of when an attribute value was changed allows a user or third party to view personal data that existed at any point in time. When an attribute value has not been updated since it was initially received, only one entry will appear in the table, such as the user's first name, last name, and primary country of residence in FIG. 2 which have only a single entry. Table 200 depicts that the user has changed their state of residence once since adding information to the repository, and has changed cities twice. The representative table can be expanded indefinitely to record other personal user information that might be stored, such as financial or other demographic information.

To store personal information, a user must first establish an account with a service provider. To establish a personal data storage account, the user may use a computer 130 with a browser capable of connecting to server 100 via a network. Once the user has connected to a website or other interface offered by the service provider, the user may establish an account by providing registration information. The minimum amount of registration information required to establish an account may be set by the service provider. Once a user has registered, the user is provided with an initial means of authentication. In some embodiments the initial means of authentication includes an alphanumeric username and password. The user may pay a fee to establish a personal data storage account, or the cost of the account may be covered or subsidized by advertising revenue or fees that third parties pay to receive access to personal information stored in the account.

Once a user has established a personal information storage account, the user and authorized third parties may add, modify, or remove information to the user's account. A user may add, modify, or remove information in a variety of ways. In some embodiments, the user stores information by answering a series of questions presented to the user by the service provider, by filling in a template presented by the service provider, or by specifying one or more attributes that the user would like to store and providing a value for each attribute. The questions, template, and attributes are presented to a user via a user interface of the system. In some embodiments, a user may use a scanner to scan documents and upload the scanned documents to the user's account.

Before a third party can add, modify, or remove information associated with a user, the third party will typically need to establish a relationship with the service provider, be authenticated by the service provider, and be granted permission by the user to supply information to the user's account. In some embodiments the third party may have a continuous relationship with the user, such as being the user's bank or employer. In some embodiments the third party may have a single interaction with the user, such as a doctor's office the user visits while on vacation.

### II. Authorizing Access to and Accessing a User's Stored Personal Information

In order to control access to a user's stored personal information, the user may set one or more access rules that define the conditions under which third parties may access the stored information. The personal information service allows significant flexibility in how access rules may be defined, thereby giving the user greater control over who may access and use their personal information. The service allows the user to control access to the personal information on a specific attribute, category of attribute, or all-attribute basis. The user may also define access rules that apply to a specific third party, to a group of third parties (e.g., to companies “A, B, and C,” to all financial institutions, to all medical institutions), or to all third parties. The service allows the user to also define whether third parties should have read access, write access, or both read and write access. For example, a user may allow all third parties read access to basic information about the user (e.g. legal name and gender), but may restrict read access to more sensitive information (e.g., date of birth, social security number, financial information). As another example, a user may allow Bank of America read access to a user's financial information but may prevent Bank of America from writing information to the user's stored financial information. The access rules may also include temporal limitations. For example, a third party may be permitted to access a user's personal information for an hour, a day, or indefinitely. As another example, a third party may only be allowed to access a user's personal information that was entered or modified after Jan. 1, 2000. The temporal limitations may also be based on a milestone or event. For example, an escrow company may be allowed to access the financial information of a user who is a party to a real estate transaction up until the real estate transaction closes, end of business on the day of the closing, twenty-four hours after the closing, a week after the closing, etc.

A user may define the access rules in advance of when a third party requires access to the user's personal information. For example, the user may specify how certain parties that the user has an ongoing relationship with (e.g., banks, medical facilities, schools) may access their personal information. When the access rules are defined in advance of when access is required to the information, the user may define the access rules from home at a computer 130 or from a user access point owned by a third party.

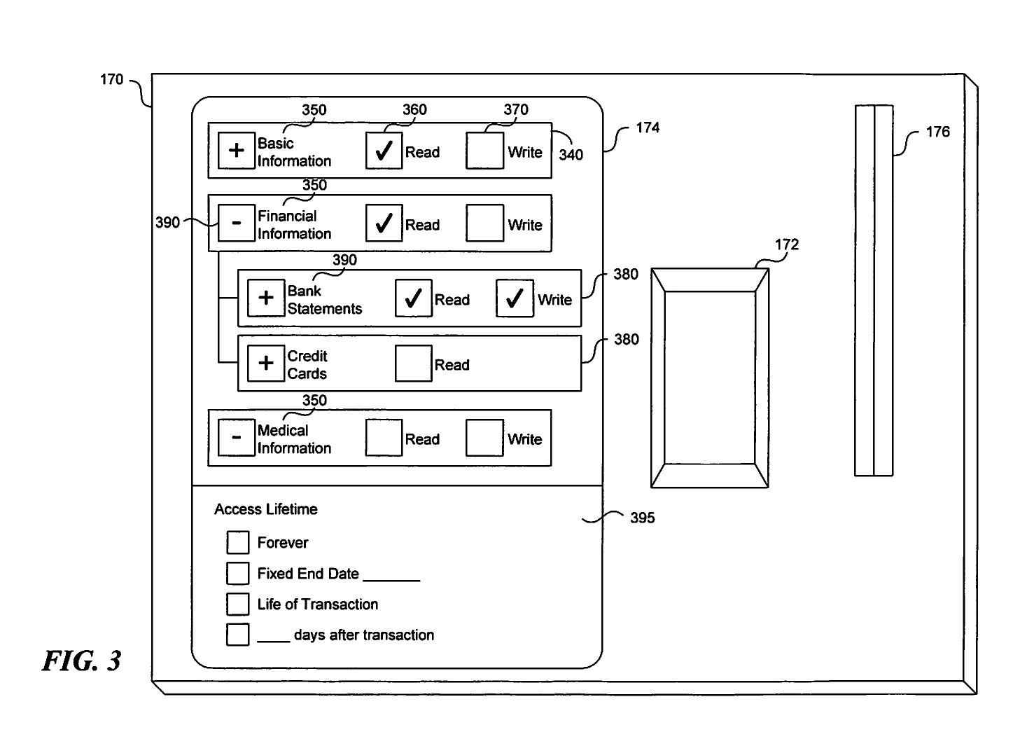

In those situations where more immediate access may need to be granted to a user's personal information, the user may use a user authentication device 170 to grant such access. User authentication devices may be operated by users or third parties, and are designed to increase the level of security provided to a user by requiring a biometric identification of the user before the user is allowed to define access rules to the user's stored personal information. FIG. 3 is a perspective diagram of a user authentication device 170, depicting the fingerprint reader 172, LCD touch screen 174, and identification scanner 176 (in the depicted case, a driver's license scanner). In general, when using a user authentication device, the user first confirms their identity to the device by using the fingerprint reader 172 and/or the identification scanner. That is, the user may place one or more fingers on the fingerprint reader which compares the read fingerprint with stored fingerprints in order to match the read fingerprint with a user identity. Additional security may be provided by also requiring the user to insert a driver's license or other identification card into the identification scanner 176. The scanned ID must match the identity of the user using the fingerprint reader. As an additional security measure, a stored photograph associated with the scanned ID can be compared to an image of the person scanning the ID to further authenticate the user. By requiring biometric and/or a scanned identification card, the user authentication device ensures that only the user may define access rules to the user's stored personal information. Those skilled in the art will appreciate that other biometric scanners used in place of the fingerprint scanner, such as a retinal scanner.

Once authenticated, the user may use an interface displayed on the LCD touch screen 174 to specify one or more access rules to the user's stored personal information. The access rules are applicable only to the third party having the user authentication device or otherwise specified by the user. As shown in FIG. 3, the interface includes various categories 350 of information that pertain to personal information stored by the user. The depicted categories include “Basic Information,” “Financial Information,” and “Medical Information,” although a greater or lesser number of categories may be displayed. For each category of information, the user may specify whether they would like to provide read access, write access, or both read and write access to the third party that is associated with the user authentication device. Read access allows the third party to view stored personal information of the user. Write access allows the third party to add information to a user's stored personal information. The user may specify whether to provide the third party read and/or write access by selecting a read check box 360 or a write check box 370. Certain categories of information may be comprised of one or more subcategories 380 of information. The user may select a control 390 to cause the subcategories of information to be displayed for the associated category. The user may specify whether to provide the third party read and/or write access to attributes falling within the subcategories by selecting the corresponding read check box or write check box. Subcategories may be further expanded (not shown) to display additional subcategories or attributes that fall within each subcategory. The user is therefore allowed to define an access rule, on an attribute, subcategory, or category basis, that is applicable to the third party having the user authentication device or otherwise specified by the user. Panel 395 allows a user to define an optional temporal limitation on the access rules. In this example, a user may set the access rules so that they last forever, until some fixed end date (e.g., Dec. 31, 2012), over the life of a particular transaction, or until some number of days after a closing event.

As shown in the menu 340, not all options may be made available for the user to select. For example, the credit card information subcategory does not allow the user to specify write access to the user's credit card information. The inclusion or omission of various menu options may be determined by the service provider, either unilaterally or based on an agreement with the user or with parties that provide personal information (e.g., credit card companies). Selection of a higher-level category or subcategory may result in the selection of each subcategory and attribute within the category or subcategory. In some embodiments, additional access rule parameters may be set by the user via the menu 340. For example, the user may be allowed to set temporal limits on when the third party may receive read and/or write access to the personal information of the user. The third party may also select whether the third party should receive access to electronic versions of documents stored by the user or by other third parties. In some embodiments, not all categories of information may be displayed to the user, such as when a third party only needs to receive access to a subset of the user's personal information.

An example of an application in which the user authentication device may have particular applicability is in the mortgage, car, or other loan process. A customer may enter a bank for the purpose of applying for a loan. The bank has multiple user authentication devices 170 to accommodate multiple customers simultaneously. The customer approaches one of the user authentication devices, authenticates himself or herself using biometric identification (e.g., fingerprint, retinal scan) and/or an identification card scan, and begins the application process. The categories of personal information necessary to complete a loan application would be displayed to the customer and the customer would grant permission to the bank to access the necessary information. Once permission is granted, the bank would be granted access to the personal information using one or more of the methods described here. A bank employee would thereby be enabled to complete the load process for the customer without the customer having to fill out paperwork or otherwise provide the necessary personal information to a bank employee.

In order to enable the described sharing of personal information between a user and a third party, various set-up processes must be completed by the user and by third parties using the user authentication device 170. If a user has never used a user authentication device, the first time that the user uses the device a set-up process must be performed. The user must initially authenticate himself or herself with the device by entering a username and password. In some embodiments, the user authentication device includes a standard keyboard with which the user can enter a username and password. In some embodiments, the user authentication device touch screen displays a keyboard to allow the user to enter a username and password. In some embodiments the user authentication device provides a CAPTCHA to further authenticate that a human user is actually accessing the device. Once the user is authenticated, the user provides additional biometric information or identification information that can be used to authenticate the user on subsequent uses of the device. For example, the user may place a finger on the fingerprint reader and have a fingerprint scanned and recorded for future verification purposes. As another example, if a retina scanner were present on the user authentication device, the user may have a retina scanned for use in future interactions with the device. In some embodiments, the user may establish a password consisting of biometric data or a combination of biometric data and alphanumeric characters. For example, a user may enter a fingerprint password, or sequence of fingerprints (e.g., <left thumb><right index finger><right thumb><left little finger><right ring finger>) that may be used to authenticate the user in the future. This provides significantly more protection because not only must the user provide a specific sequence of fingerprints, but the user's biometric data for each scanned finger is also verified with each scan.

The user may also establish multiple passwords to be used for different purposes. For example, an “admin-level” password may be created to provide the user with administrative level access (i.e., access with no limitations) to the user's information repository while a “low-level” password may be created to provide the user with more limited access to the information repository. Authentication information requirements for an admin-level password may be stronger than those required for a low-level password. For example, an admin-level password may require a sequence of at least ten alpha-numeric characters or fingerprints while the low-level password requires a sequence of six alpha-numeric characters or fingerprints. The user may use the low-level password when accessing the information repository in a public place, such as within a bank. When using the low-level password, the user may be presented with a minimal menu and a minimal set of access and sharing rights so that the user does not inadvertently grant access to a third party and so that privileged information is not accidentally displayed to bank employees or other customers. In some embodiments, the user may customize the access and display behavior associated with each of the passwords.

A user may also establish a “duress” password. A user enters this password to indicate that they are being forced to access their information repository against their will. When a system recognizes this password, the system may notify emergency services of the user's location and record subsequent transactions as being made under duress so that they can be rolled back automatically once the user's safety is secured.

Once the user has established an account and determined a means for authentication, the user may access their personal information and authorize third parties to access and/or modify the stored information. The system may also rate the user using an Overall Score consisting of a number of independent or dependent sub-scores. For example, an “Authentication Score” may be based on the type and extent of authentication information the user has provided. For example, a user who has provided only an alphanumeric username and password may receive a relatively low Authentication Score while a user who provides an alphanumeric username and password, ten fingerprints, an eight digit fingerprint sequence, and a retinal scan may receive a relatively high Authentication Score. Other sub-scores may include an Identification Score, a Documentation Score, a Valid Activity Score, an Awareness Score, a Documentation Coverage Score, a Vender Activity Score. Third parties may use these scores to, for example, identify potential customers or to eliminate certain candidates for certain opportunities. For example, a potential employer may only offer interviews or positions to candidates having a Documentation Score or Overall Score that exceeds some predetermined threshold. In some embodiments, the Overall Score may be determined based on some combination of the sub-scores, such as a weighted sum, an average, or the minimum sub-score.

In addition to a user set-up process, any third party that desires to install a user authentication device at a location may also complete a set-up process with the service provider. The third party may establish a relationship with the service provider by submitting account registration information to the service provider, such as the name of the third party, its physical address, type of business, financial information, etc. The service provider may also require the third party to demonstrate that it has sufficient processes and procedures in place to ensure the proper use and confidentiality of user personal information that it receives. In some embodiments, the third party may be required to specify the type of information that it needs to access when working with users, thereby allowing the service provider to globally limit the amount of information that would be shared with the third party. For example, the service provider may allow a bank to receive access to the financial information of users, but not to the health information of users. In some embodiments, the third party pays a fee for access to the personal information of users, such as a yearly fee, a monthly fee, or a per-use fee.

Once a business relationship is established between the service provider and the third party, the user authentication device may be deployed at the premises of the third party. Various mechanisms may be used to authenticate the user authentication device when it is used by a user. In some embodiments the service provider authenticates the third party authentication device by a unique identifier that is embedded in the hardware and/or software of the device. Security may be further enhanced by ensuring that the authentication device only communicates with the service provider system via a known address on a computer network. In some embodiments, the service provider further authenticates the device and third party by requiring that the third party provide a username and password when initializing or prior to using the device. Those skilled in the art will appreciate that other mechanisms for authenticating the user authentication device and/or third party may be used. For example, the authentication device may transmit an encrypted token or certificate embedded within the authentication device to the service provider from a secure network address to ensure that the authentication device is operating with a secure environment of the third party.

When a user has used a user authentication device to authorize a third party to receive personal information about the user, the service provider may deliver the information to the third party in a variety of ways. The service provider may, for example, allow backend computer systems of the third party to access the information repository 110 via service calls using a service provider-defined API. The third party may make such calls to the service provider immediately after receiving authorization from a user, or may aggregate authorizations from a number of users and make a single batch call on a periodic basis (e.g. hourly, daily). As another example, the service provider may transmit the authorized personal information directly to the backend computer systems of the third party after receiving the appropriate authorization from the user. Such a transmission may be completed using a predefined communication protocol and path that is negotiated between the service provider and the third party. The personal information associated with the user may be communicated across private networks or across public networks, provided that appropriate security measures such as encryption are used to protect the confidentiality of the user's personal information.

### III. Viewing a User's Personal Information

As was previously described, personal information is stored as individual attributes in the information repository 110. That is, each piece of information associated with a user is preferably stored only once in the information repository. Storing each piece of personal information in this fashion allows the information to be easily presented to users or to third parties in a variety of different formats. For example, the user may find it beneficial to view his or her personal information in a table similar to that shown in FIG. 2. As another example, various templates may be created by the service provider or by third parties to view pre-determined collections of personal information. A template is a document that contains fixed textual and/or graphical portions as well as fields that are populated by retrieving attribute information from the information repository. Templates allow a user or a third party to view attribute information in a form which the viewer may be more familiar with. For example, a template may be created to display a portion of a user's medical record. The template may include all of the language of a standard medical form and linked fields for each portion of the document that is personal to an individual. A party who has authorized access and wishes to view a portion of the user's medical record may access the template, and the empty fields of the template will be automatically populated with the appropriate attributes from the information repository. The templates may be created and customized by the service provider, by third parties, or by users.

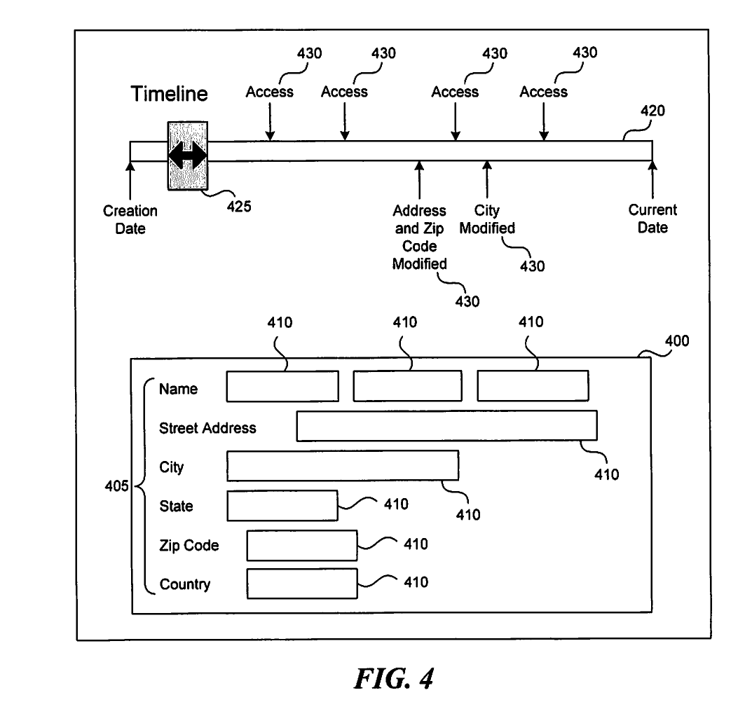

FIG. 4 is a user interface that allows a user or third party to access and display personal information in a template. Because a user's personal information will typically change over time, the user interface allows a viewer to view a user's personal information at any point in the past starting from when the personal information was first stored by the system and ending with the present date. A representative template 400 that allows a viewer to view a subset of a user's stored personal information is depicted in the figure. The template includes textual labels 405 that remain constant in the template and identify the associated attribute that is displayed by the system. The template also includes dynamic fields 410 that display a user's attribute information. When a party accesses the template, the dynamic fields are populated with information from the information repository. For example, in FIG. 4, the user's name, address, city, state, zip code and country will be retrieved from the information repository and populated to the appropriate dynamic field in the template. A timeline 420 is depicted at the top of the user interface. The timeline allows users to select a date and have the template populated with the user's personal information that was current on that date. The date may be selected using a slider 425. When the slider is at the left-most position on the timeline (the creation date), the template depicts the corresponding personal information that was initially populated for the user. When the slider is in the right-most position on the timeline (the current date), the template depicts the most current version of the personal information. By moving the slider to any intermediate position on the timeline, a viewer may see the personal information of the user at the time represented by the slider. Various events 430 may be depicted on the timeline. An event may reflect a change to one or more of the attributes that is displayed in the template. For example, one of the events on timeline 420 indicates that the address and zip code of the user's personal information was modified. An event may also indicate an access to the template. For example, one of the events on timeline 420 indicates that the template with the user's personal information was accessed by a third party. Clicking on or otherwise selecting the event may provide additional detail about the event, such as the identity of the party (e.g., USER036) associated with the event and the timestamp associated with the event (e.g., 9:36 AM on 26 Jan. 2006). By moving the slider back and forth along the timeline, the viewer may thereby view the template as it would be populated with data at that time. Those skilled the art will appreciate that the historical personal information may be readily shown to a viewer because the system maintains a record of previous attribute values as depicted in FIG. 2.

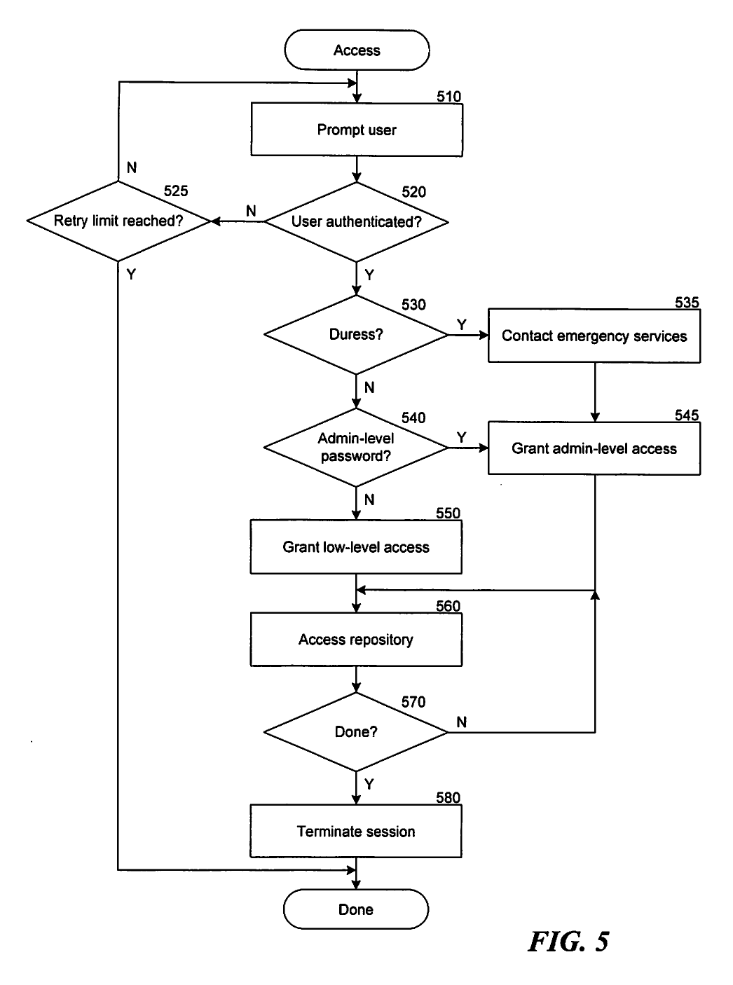

FIG. 5 is a flow diagram illustrating steps performed by an access component of the personal information system. The access component authenticates a user and allows the user to access their information repository and may be invoked by a user at, for example, a home computer, work computer, or authentication device 170. In block 510, the access component prompts the user for authentication information (i.e., credentials). For example, the system may prompt the user to enter a user name and password, prompt the user to scan an identification card or provide a radio-frequency identification (RFID) tag, collect biometric data from the user, or some combination thereof. In decision block 520, if the user is authenticated, the component continues at decision block 530, else the component continues at decision block 525. In decision block 525, if a retry limit has been reached, processing of the component completes and the user is precluded from accessing personal information on a temporary or permanent basis (e.g., for an elapsed time period, until account access is reset by the system operator, etc.). If a retry limit has not been reached, the component continues at block 510 to re-prompt the user for authentication information. In decision block 530, if the authentication information provided by the user indicates that the user is under duress, the component continues at block 535, else the component continues at decision block 540. In block 535, the component contacts and notifies emergency services (e.g., the police or building security) that the user has indicated that they are under duress. The component then continues at block 545. In decision block 540, if the user has provided an admin-level password, the component continues at block 545, else the component continues at block 550. In block 545 the component grants the user admin-level access (i.e., unlimited) to their information repository. The user is thereby allowed to add, modify, delete, and control access to stored personal information and documents. In block 550, the component grants the user low-level access to their information repository. The user is thereby allowed limited access to add, modify, delete, and control access to stored personal information and documents. In block 560, the component allows the user to access their information repository in accordance with the granted access level. The component displays a navigation menu through which a user can, for example, add or remove document from their information repository, edit documents within the information repository, modify privileges associated with a document or a group of documents within the repository, etc. In decision block 570, if the user is done then the component continues at block 580, else the component loops back to block 560 to allow the user to continue to access their information repository. In block 580, the component terminates the session with the user and processing of the component completes. For example, the user may close any secure connections created during the access session and remove any local files created during the process that may contain secure information.

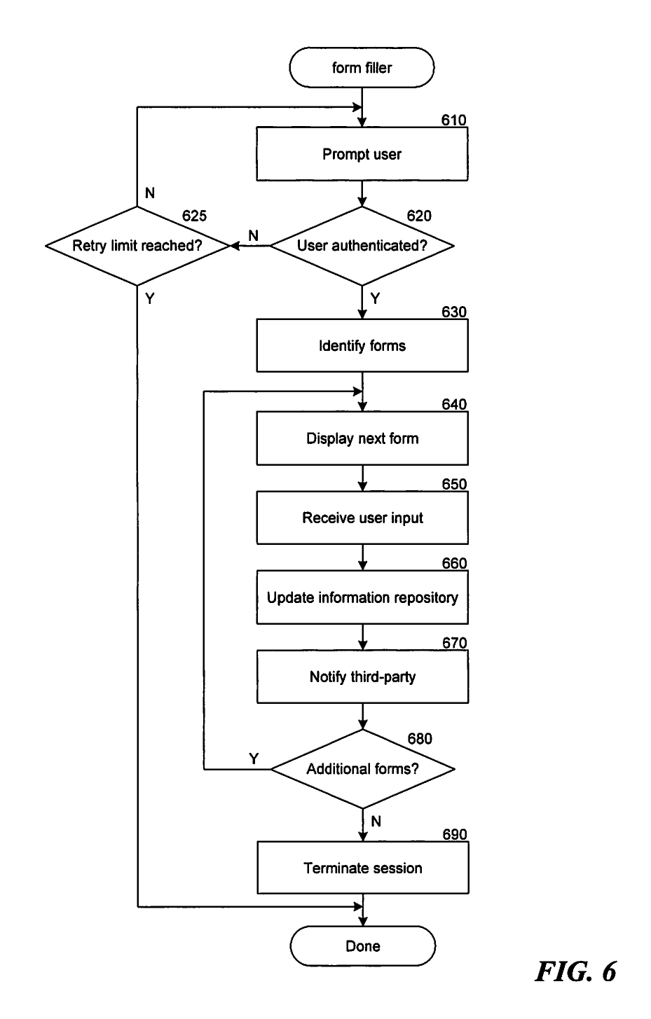

FIG. 6 is a flow diagram illustrating steps performed by a form filler component of the personal information system. The form filler component authenticates a user, retrieves user information for populating forms provided by a third party, such as a doctor's office or government agency, and allows the user to access and manipulate the forms. The form filler component may be invoked by a user at, for example, a home computer, work computer, or authentication device provided by the third party. In block 610, the component prompts the user for authentication information (i.e., credentials). In decision block 620, if the user is authenticated, the component continues at block 630, else the component continues at decision block 625. In decision block 625, if a retry limit has been reached, processing of the component completes and the user is precluded from filling out forms. If the retry limit has not been reached, the component continues at block 610 to re-prompt the user for authentication information. In block 630, the component identifies forms to be displayed to the user. For example, if the user is at a doctor's office or performing a medical transaction, the component may identify the necessary forms related to the user's medical records, insurance information, emergency contact information, etc. The access component may remove from the list of identified forms any forms for which information has already been collected. Alternatively, the component may prompt the user to indicate whether updates to any of the forms for which information has already been collected. In block 640, the component displays the next of the identified forms to display to the user. Displaying the form may include retrieving information from the information repository associated with the user and populating the appropriate fields of the form. However, if the user has not authorized the third party to access certain information, based on the user's access rules, fields associated with that information will be left blank. The user will then be permitted to complete the blank fields and/or modify the completed fields via the authentication device. In some embodiments, the component may flag the blank fields in red, for example, and allow a user to override the rules in order to automatically import data on a field-by-field basis. In block 650, the component receives user input. For example, the user may input the name of their insurance provider and their policy number into a form related to insurance information. As another example, the user may modify information automatically added to a field of the form by the component. The component may send these changes to the user's information repository for storage and later retrieval. The component may also validate information entered into the form. For example, the component may verify that the policy number entered by the user is properly formatted for the user's insurance provider. In block 660, the component updates the user's information repository based on the received information. In block 670, the component notifies the third party that the user's information repository has been updated using one of the third party's forms. Additionally, the component may send the third party an electronic copy of the completed form. In decision block 680, if there are additional forms, the component loops back to block 640 to display the next form, else the component continues at block 690. In block 690, the component terminates the session with the user and processing of the component completes.

Those skilled in the art will appreciate that various changes may be made to how the timeline is displayed to a viewer. In some embodiments, the timeline is implemented with a dropdown list of dates representing changes in attribute values for the template. In some embodiments, the timeline is implemented using a calendar display that allows a viewer to select a particular date. Template population may be limited to remain consistent with the viewer's authorization to view the information. A third party will be unable to view attributes to which it does not have permission, nor will a third party be able to view attributes for a time period during which the third party has not been granted permission.

Those skilled in the art will appreciate that various changes to the system may be made while still providing similar or identical functionality. For example, multiple service providers may exist, each storing the personal information associated with a group of users. Additionally, a service provider may structure information repositories in a variety of environments including a single, monolithic computer system or a distributed system, as well as various other combinations of computer systems or similar devices connected in various ways. Furthermore, users may access personal information through any combinations of computer systems or similar devices connected in various ways. From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/We claim:

1. A method performed by a computing device having a memory and a processor for providing secure access to user information associated with a plurality of users, the method comprising:
for each of a plurality of users, each user having an associated information repository that stores values of one or more attributes of the user,
receiving first authentication information from the user,
authenticating the user based on the received first authentication information, and
receiving an indication of a plurality of access rules, each access rule defining permissions of at least one third party for accessing the information repository associated with the user; and
for each of a plurality of third parties,
receiving second authentication information from the third party,
authenticating the third party based on the received second authentication information,
receiving from the third party an indication of a first request to access a first information repository associated with a first user, and
upon determining, based at least in part on at least one access rule defined by the first user, that the third party is permitted to access the first information repository in accordance with the first request,
accessing the first information repository in accordance with the first request.

2. The method of claim 1 wherein the first authentication information includes a sequence of fingerprints.

3. The method of claim 2 wherein authenticating the user based on the received first authentication information includes determining whether each fingerprint in the sequence of fingerprints belongs to the user and determining whether the sequence of fingerprints matches a stored user fingerprint password.

4. The method of claim 1 wherein updating the information repository based at least in part on the received value includes storing an indication of the received value and an associated time value.

5. The method of claim 1 wherein the first request is a request to retrieve a value for a first attribute of the first information repository and wherein accessing the first information repository includes retrieving from the first information repository a value for the first attribute.

6. The method of claim 5, further comprising:
encrypting the retrieved value for the first attribute; and
sending to the third party an indication of the encrypted retrieved attribute value.

7. The method of claim 1 wherein the first request is a request to store a value for a first attribute of the information repository and wherein accessing the first information repository includes storing in the first information repository the value for the first attribute.

8. A computer-readable storage medium containing instructions, that when executed by a computing device having a memory and a processor, cause the computing device to perform a method for accessing personal information, the method comprising:
identifying, based on a received biometric password, a user, the user being associated with personal information stored in an information repository and a set of access rules for accessing the personal information stored in the information repository;
identifying, based on received credentials, a third party;
identifying at least one form associated with the third party, each form containing at least one field; and
for each of the identified at least one forms,
for each of the at least one field of the form,
upon determining, based at least in part on the access rules stored by the information repository, that the third party is permitted to access the information repository to populate the field,
retrieving a value of an attribute of personal information from the information repository, and
populating the field with the retrieved attribute value, and
sending an indication of the form containing fields populated with attribute values to the third party.

9. The computer-readable storage medium of claim 8, the method further comprising:
upon determining, based on the access rules, that the third party is not permitted to access the information repository to populate the field, prompting the user.

10. The computer-readable storage medium of claim 8, the method further comprising:
displaying an indication of at least one of the identified at least one forms; and
displaying a date selector.

11. The computer-readable storage medium of claim 8, wherein retrieving a value from the information repository includes retrieving a value based on the currently selected date of the displayed date selector.

12. The computer-readable storage medium of claim 8, wherein the biometric password is a sequence of fingerprints.

13. The computer-readable storage medium of claim 8, wherein the received credentials includes an encrypted token and an address on a computer network.

14. A computing device having a memory and a processor for authenticating a user accessing an information repository associated with the user, the computing device comprising:
a component that collects biometric data;
a component that, upon determining that the collected biometric data corresponds to a user, authenticates the user;
a component that displays a navigation menu for navigating the information repository associated with the user, the component configured to allow a user to specify access rules to personal information associated with the user that is stored in the information repository; and
a component that accesses the information repository associated with the user based at least in part on commands received from the user through the displayed navigation menu to retrieve personal information of the user in accordance with the access rules.

15. The computing device of claim 14 wherein the collected biometric data is a sequence of biometric data corresponding to biometric password associated with the user.

16. The computing device of claim 15, wherein the biometric password is an admin-level password requiring a sequence of at least ten biometric data values.

17. The computing device of claim 16, wherein the sequence of at least ten biometric data values includes at least one fingerprint.

18. The computing device of claim 16, wherein the sequence of at least ten biometric data values includes at least one biometric data value that is not a fingerprint.

19. The computing device of claim 15, further comprising:
a component that, in response to receiving a biometric password corresponding to a duress password associated with the user, contacts emergency services.

20. The computing device of claim 15, further comprising:
a component that displays a third party form; and
a component that retrieves information from the information repository and automatically populates fields of the displayed third party form with the retrieved information.
